(19) United States
(12) Patent Application Publication
(10) Pub. No.: US 2012/0246602 A1
(43) Pub. Date: Sep. 27, 2012

(54) METHOD OF PREPARING PATTERN, METHOD OF MANUFACTURING SEMICONDUCTOR DEVICE, AND COMPUTER PROGRAM PRODUCT

(76) Inventors: Sachiko Kobayashi, Chiba (JP); Satoshi Tanaka, Kanagawa (JP); Shigeki Nojima, Kanagawa (JP); Kazuhiro Takahata, Kanagawa (JP)

(21) Appl. No.: 13/237,663

(22) Filed: Sep. 20, 2011

(30) Foreign Application Priority Data
Mar. 23, 2011 (JP) 2011-064319

(51) Int. Cl. G06F 17/50

(52) U.S. Cl. 716/53; 716/55

(57) ABSTRACT

An embodiment provides a method of preparing a pattern. In the pattern preparing method, when mask patterns corresponding to on-substrate patterns are prepared to form the on-substrate patterns corresponding to design patterns, the mask patterns are prepared based on a correlation which needs to be satisfied between the design patterns so that a relation which same the correlation can be satisfied between the mask patterns corresponding to the design patterns.

### CROSS-REFERENCE TO RELATED APPLICATIONS

This application is based upon and claims the benefit of priority from Japanese Patent Application No. 2011-064319, filed on Mar. 23, 2011; the entire contents of which are incorporated herein by reference.

### FIELD

Embodiments described herein relate generally to a method of preparing a pattern, a method of manufacturing a semiconductor device, and a computer program product.

### BACKGROUND

In designing and manufacturing semiconductor devices, circuit patterns having small design margins are being increasingly used, with a miniaturization trend in patterns. This increases the number of portions vulnerable to dimension variations (portions where desired electrical functions may not be obtained). In addition, circuits sensitive to noise such as analog circuits have to satisfy some requirements for obtaining desired device characteristics. Examples of such requirements include relative positions, sizes, shapes, and lengths between patterns (design blocks, or circuits) as well as the dimensions of each pattern.

However, in the related art, it is difficult to extract such requirements as designer's intention and hence to use the extracted requirements in manufacturing. For example, in a design step, circuit patterns (design layout) are prepared taking electric characteristics into consideration such as timing, crosstalk, and reliability, and further taking relations between respective blocks and patterns into consideration. However, a manufacturer receives a design layout constituted by a plurality of layers and forms patterns to implement dimensions and shapes of the layout through manufacturing processes. Therefore, it is difficult to perform the manufacturing processes in which important portions in terms of electric characteristics and relative positions between patterns are considered, and hence the process yield of circuits decreases.

In addition, since it is difficult to add specifications about positional relations between patterns to a design layout, excessive margins may be considered in a design step. However, in this case, all elements of the entire design layout need to be designed in excessive dimensions, and thus the size of chips increases. Therefore, it is longed for manufacturing semiconductor devices with high production yield and at low costs.

### BRIEF DESCRIPTION OF THE DRAWINGS

FIG. 1 is a view illustrating a mask pattern preparing system according to a first embodiment;

FIG. 2 is a view illustrating exemplary requirements;

FIGS. 3A to 3D are views for describing an exemplary process of preparing mask patterns based on relative information;

FIG. 4 is a view illustrating a mask pattern preparing system according to a second embodiment;

FIG. 5 is a view illustrating a relation between a design layout and on-wafer patterns;

FIGS. 6A and 6B are views for describing a process of correcting mask patterns for circuit patterns requiring areal symmetry;

FIGS. 7A and 7B are views for describing a process of correcting mask patterns for circuit patterns requiring length symmetry;

FIG. 8 is a flowchart illustrating a process of preparing a dose map based on relative information; and

FIG. 9 is a view illustrating the hardware structure of a mask pattern preparing apparatus.

### DETAILED DESCRIPTION

Embodiments provide a method of preparing a pattern. In the pattern preparing method, when mask patterns corresponding to on-substrate patterns are prepared to form the on-substrate patterns corresponding to design patterns on a substrate, the mask patterns are prepared based on a correlation which the design patterns need to satisfy so that a relation which same the correlation can be satisfied between the mask patterns corresponding to the design patterns.

Hereinafter, a method of preparing a pattern, a method of manufacturing a semiconductor device, and a computer program product will be described in detail according to embodiments with reference to the accompanying drawings. However, the present invention is not limited to the embodiments.

### First Embodiment

When mask patterns are prepared, a lithography simulation is repeated to optimize the mask patterns so that on-wafer patterns having desired shapes can be formed. Although input layout groups (design patterns) or close design patterns have the same shape, since grid (lattice point) deviation or grid turning (grid error) is accumulated during the lithography simulation, the mask patterns may not have the same shape after optical proximity correction (OPC). Therefore, according to the current embodiment, when a design layout is delivered, a file is delivered together with the design layout to provide requirement information (hereinafter referred to as relative information) regarding a correlation (relative relation) between design patterns. Then, mask patterns are prepared based on the relative information. For example, if there is a pair of design patterns for forming mask patterns having the same shape, the design patterns are converted to mask patterns having the same shape.

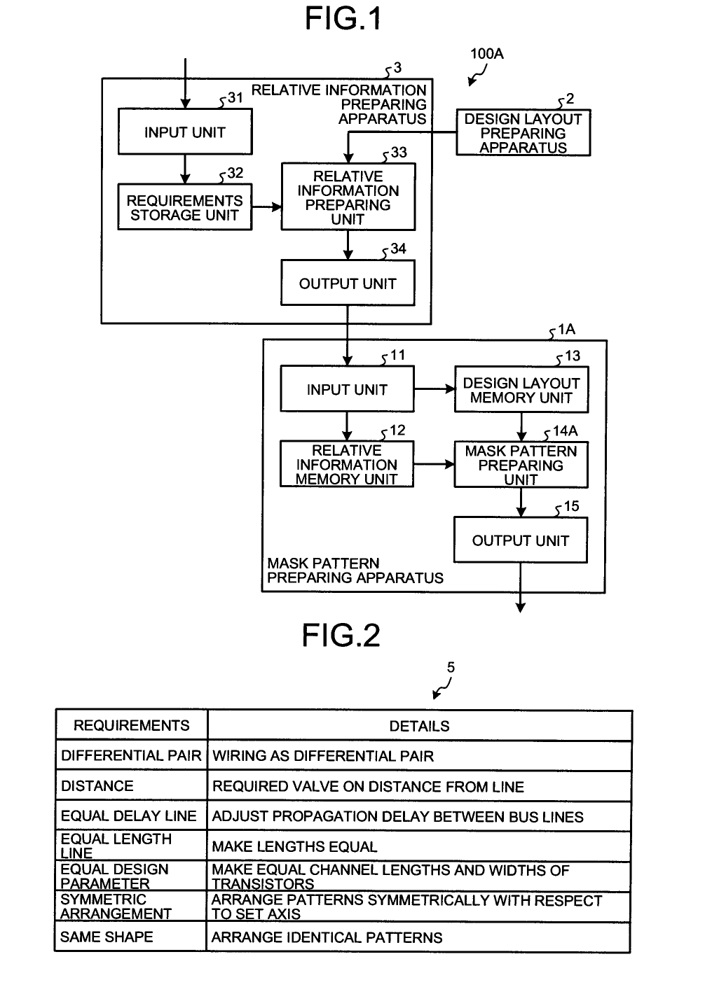

FIG. 1 is a diagram illustrating a configuration of a mask pattern preparing system according to a first embodiment. The mask pattern preparing system 100A includes a mask pattern preparing apparatus 1A, a design layout preparing apparatus 2, and a relative information preparing apparatus 3.

The design layout preparing apparatus 2 is an apparatus such as a computer for preparing a design layout (data about shapes, dimensions, and arrangement positions of a plurality of design patterns) of semiconductor devices (semiconductor integrated circuits). The design layout preparing apparatus 2 prepares a design layout according to requirements 5 (described later). Design patterns are required to satisfy the requirements 5 for manufacturing semiconductor devices with desired circuit functions. The design layout preparing apparatus 2 sends the prepared design layout to the relative information preparing apparatus 3.

The relative information preparing apparatus 3 is an apparatus such as a computer for preparing relative information of mask patterns corresponding to the design patterns based on the design layout and the requirements 5 of the design patterns included in the design layout. The requirements 5 of the design patterns are requirements between the design patterns (design blocks, circuits, and respective (individual) patterns). In addition, the relative information relates to requirements between mask patterns or on-wafer patterns. In the current embodiment, the relative information relates to requirements between mask patterns.

The relative information preparing apparatus 3 includes an input unit 31, a requirement memory unit 32, a relative information preparing unit 33, and an output unit 34. The input unit 31 receives the requirements 5 for the design patterns and sends the requirements 5 to the requirement memory unit 32. The requirement memory unit 32 is a memory for storing the requirements 5.

The requirements 5 will now be described in detail. FIG. 2 is a diagram illustrating examples of the requirements. The requirements 5 regulate correlations between on-wafer patterns. The requirements 5 include ‘items’ and corresponding ‘details.’ Examples of ‘items’ include ‘differential pair,’ distance, ‘equal delay line,’ ‘equal length line,’ ‘equal design parameter,’ ‘symmetric arrangement,’ and ‘same shape.’

‘Differential pair’ is a requirement for forming line patterns. For example, a circuit functioning as a differential pair is required to be symmetrically formed by matching things such as lengths of a circuit pair, bent portion numbers (curved portion numbers), bent angles, left and right symmetry, and via numbers.

‘Distance’ is a required value regarding a distance from a pattern line. ‘Equal delay line’ is a requirement for adjusting patterns according to a propagation delay between bus lines. For example, the requirement ‘equal delay line’ regulates things such as an equal length and an equal area of patterns to match delays between the patterns.

‘Equal length line’ is a requirement for adjusting pattern dimensions to equal lengths. ‘Equal design parameter’ is a requirement for making uniform design parameters such as channel lengths and widths of transistors. In the case of an element group required to have transistor characteristics, it may be necessary to match channel lengths, widths, and shapes for suppressing manufacturing deviations.

Symmetry may be important for circuits such as a current mirror circuit. ‘Symmetric arrangement’ is a requirement for arranging patterns at symmetric positions such as linearly symmetric positions, for example, by locating patterns at symmetric positions with respect to a set axis. ‘Same shape’ is a requirement for arranging identical patterns (patterns having the same shapes and dimensions).

The relative information preparing unit 33 derives requirements to be imposed on design patterns based on the requirements 5 and prepares relative information based on the derived requirements. For example, the relative information preparing unit 33 calculates a relation between relative positions of circuit patterns and circuit characteristic dependency based on electric characteristics of the circuit patterns derived from a design layout, so as to prepare relative information for satisfying the requirements 5.

For example, if two design patterns (e.g., design patterns Ax and Bx) are regulated by ‘same shape’ of the requirements 5, the relative information preparing unit 33 prepares relative information (Ax=Bx) by matching the two design patterns Ax and Bx with ‘same shape’ requirement. The output unit 34 outputs the design layout and the relative information prepared by the relative information preparing unit 33 to the mask pattern preparing apparatus 1A.

Alternatively, the design layout preparing apparatus 2 may has the function of the relative information preparing apparatus 3. In this case, the design layout preparing apparatus 2 may prepare a design layout and relative information at the same time. For example, when pattern data for design patterns Ax and Bx are prepared, if the design patterns Ax and Bx are regulated by ‘same shape’ of the requirements 5, the design patterns Ax and Bx are prepared to have the same shape. Then, relative information is prepared by matching ‘same shape’ requirement with the design patterns Ax and Bx.

The mask pattern preparing apparatus 1A is a computer for preparing mask patterns based on the design layout and the relative information. The mask pattern preparing apparatus 1A includes an input unit 11, a relative information memory unit 12, a design layout memory unit 13, a mask pattern preparing unit 14A, and an output unit 15.

The input unit 11 receives the relative information from the relative information preparing apparatus 3 and sends the relative information to the relative information memory unit 12. In addition, the input unit 11 receives the design layout from the relative information preparing apparatus 3 and sends the design layout to the design layout memory unit 13. Alternatively, the input unit 11 may receive the design layout from the design layout preparing apparatus 2. The relative information memory unit 12 is a device such as a memory for storing the relative information, and the design layout memory unit 13 is a device such as a memory for storing the design layout.

The mask pattern preparing unit 14A prepares mask patterns using the relative information and the design layout. The mask pattern preparing unit 14A prepares a lithography target by performing mask data processing (MDP) using design data. In addition, the mask pattern preparing unit 14A prepares OPC-processed mask patterns by performing OPC on the lithography target. In the current embodiment, the mask pattern preparing unit 14A may prepare mask patterns based on the relative information through an OPC process, or the mask pattern preparing unit 14A may prepare mask patterns through an OPC process and correct the mask patterns based on the relative information.

For example, in case of preparing mask patterns Am and Bm from design patterns Ax and Bx with relative information of ‘same shape’ (Ax=Bx), the mask pattern preparing unit 14A prepares identical mask patterns as the mask patterns Am and Bm. The output unit 15 outputs the mask patterns prepared by the mask pattern preparing unit 14A to an external apparatus (such as display device or electron beam lithography system).

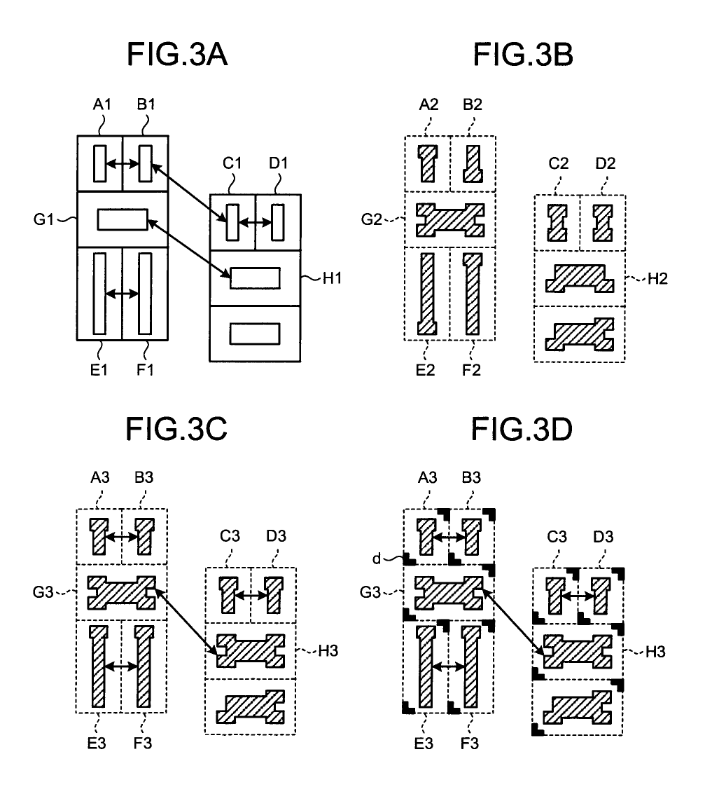

Next, an explanation will be given on a process of preparing mask patterns based on relative information. FIGS. 3A to 3D are diagrams for describing an exemplary process of making mask patterns based on relative information. In the following description, relative information is ‘same shape.’ FIG. 3A illustrates exemplary design patterns. In FIG. 3A, design patterns A1 to H1 are shown as exemplary design patterns.

Although it is intended to form fine patterns on a substrate (such as a wafer) through an exposing process, the patterns may not be formed in desired shapes on the wafer due to optical properties such as refraction and interference (optical proximity effect). Therefore, mask patterns are corrected (optical proximity correction, OPC) so as to form on-wafer patterns having desired shapes. FIG. 3B illustrates mask patterns A2 to H2 prepared through OPC without considering relative information. The mask patterns A2 to H2 correspond to the design patterns A1 to H1, respectively.

According to the current embodiment, when an OPC process is performed, the mask pattern preparing unit 14A prepares mask patterns based on relative information. FIG. 3C illustrates mask patterns prepared through an OPC process based on relative information. Here, the relative information ‘same shape’ is A1=B1=C1=D1, E1=F1, and G1=H1. In this case, mask patterns A3 to D3 having the same shape are formed as mask patterns corresponding to the design patterns A1 to D1. Similarly, mask patterns E3 and F3 having the same shape are formed as mask patterns corresponding to the design patterns E1 and F1, and mask patterns G3 and H3 having the same shape are formed as mask patterns corresponding to the design patterns G1 and H1.

When forming such mask patterns, dummy patterns such as sub resolution assist features (SRAF) may be disposed close to the mask patterns. FIG. 3D illustrates mask patterns prepared using dummy patterns. In the current embodiment, the mask pattern preparing unit 14A arranges dummy patterns close to mask patterns in a manner such that equivalent dummy patterns are arranged at groups of pattern having the same shape.

Here, the mask pattern preparing unit 14A arranges dummy patterns (d) having the same shape in a manner such that the dummy patterns (d) are arranged at the same relative positions for mask patterns A3 and D3 corresponding to the design patterns A1 to D1. In other words, the dummy patterns (d) are arranged in a manner such that pattern groups constituted by mask patterns and the dummy patterns (d) close to the mask pattern are identical. For example, the dummy patterns (d) are arranged in a manner such that a pattern group constituted by the mask pattern A3 and the dummy patterns (d) close to the mask pattern A3 is identical to a pattern group constituted by the mask pattern B3 and the dummy patterns (d) close to the mask pattern B3.

Similarly, the mask pattern preparing unit 14A arranges dummy patterns (d) having the same shape at the same relative positions for the mask patterns E3 and F3, and dummy patterns (d) having the same shape at the same relative positions for the mask patterns G3 and H3.

In this way, influence caused by various arrangements of patterns (such as optical proximity effect) can be decreased, and thus deviations of on-wafer patterns can be reduced. Therefore, on-wafer patterns having the same shapes can be formed.

For example, the mask pattern preparing system 100A may prepare mask patterns for each layer in a wafer process. Thereafter, semiconductor devices are manufactured using the mask patterns prepared by the mask pattern preparing apparatus 1A. In detail, a mask (photomask) is prepared by using the mask patterns, and an exposure process is performed on a wafer coated with a resist by using the mask. Then, the wafer is developed to form resist patterns on the wafer. Thereafter, a layer under the resist patterns is etched by using the resist patterns as a mask. In this way, patterns corresponding to the resist patterns are formed on the wafer. When semiconductor devices are formed, processes such as the above-described relative information preparing process, mask pattern preparing process, exposure process, development process, and etching process are repeated for each layer.

In the current embodiment, although an explanation has been given of the case where line patterns are arranged in accordance with requirement information, hole patterns such as vias or contacts may be arranged in accordance with requirement information.

As described above, according to the first embodiment, since mask patterns are formed based on relative information, designed patterns can be formed on a wafer according to designed pattern groups. Therefore, deviations of on-wafer patterns can be reduced, and thus circuits having desired electric functions can be formed with improved process yield. Therefore, semiconductor devices can be manufactured with high process yield and low costs.

### Second Embodiment

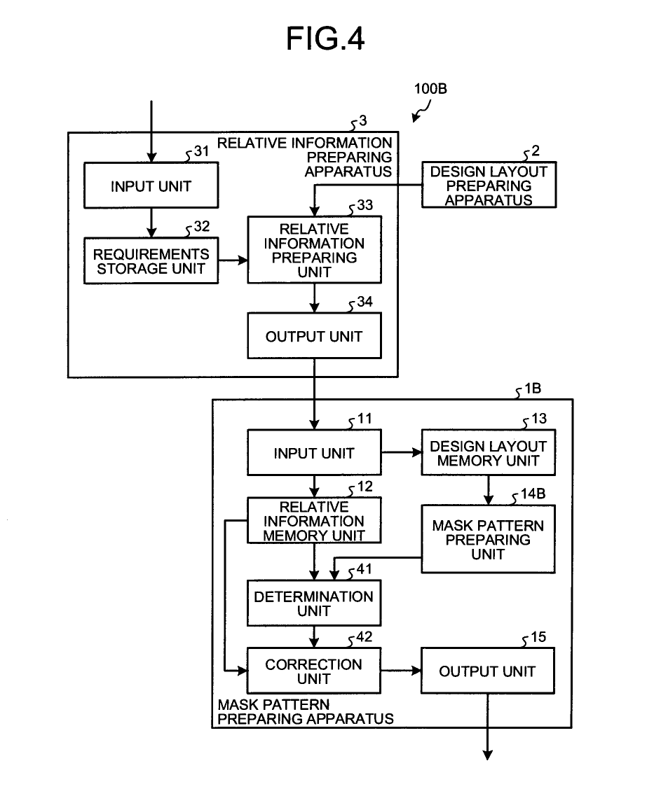

Next, a second embodiment of the present invention will be described with reference to FIGS. 4 to 7. In the second embodiment, for example, mask patterns are corrected (compensated for) so that on-wafer patterns can be formed according to relative information.

FIG. 4 is a view illustrating a mask pattern preparing system according to the second embodiment. In FIG. 4, elements having the same functions as those of the mask pattern preparing system 100A of FIG. 1 of the first embodiment are denoted by the same reference numerals, and descriptions thereof are not repeated. In the current embodiment, relative information is about requirements between on-wafer patterns.

The mask pattern preparing system 100B includes a mask pattern preparing apparatus 1B, a design layout preparing apparatus 2, and a relative information preparing apparatus 3. The mask pattern preparing apparatus 1B includes an input unit 11, a relative information memory unit 12, a design layout memory unit 13, a mask pattern preparing unit 14B, an output unit 15, a determination unit 41, and a correction unit 42.

The mask pattern preparing unit 14B prepares mask patterns using a design layout through an OPC process. The mask pattern preparing unit 14B sends the prepared mask patterns to the determination unit 41.

The determination unit 41 determines whether patterns (on-wafer patterns) satisfying relative information can be formed on a wafer by using the mask patterns prepared by the mask pattern preparing unit 14B (OK or NG determination). In the current embodiment, the determination unit 41 performs the determination process for mask patterns corresponding to design patterns regulated by relative information. Alternatively, the determination unit 41 may perform the pattern determination process for all the mask patterns. The determination unit 41 sends the pattern determination result and the mask patterns to the correction unit 42. The determination result includes information about mask patterns determined as NG.

The correction unit 42 corrects mask patterns determined not suitable for forming on-wafer patterns satisfying the relative information. The correction unit 42 corrects the mask patterns so that on-wafer patterns satisfying the relative information can be formed on a wafer by using the corrected mask patterns. The correction unit 42 sends the corrected mask patterns to the output unit 15. If there is no mask pattern determined as NG, the correction unit 42 sends the mask patterns to the output unit 15 without correcting the mask patterns.

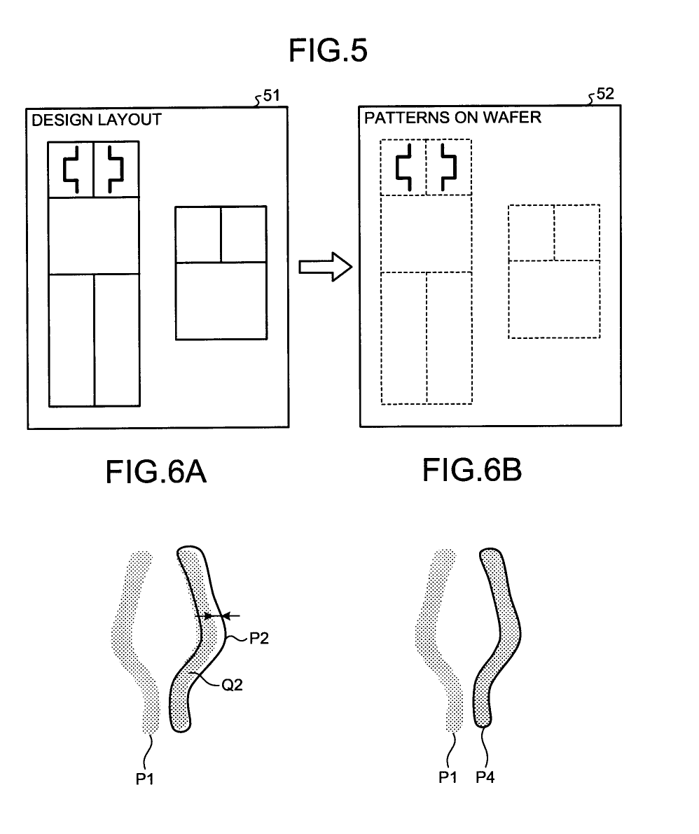

Next, an explanation will be given on a process of determining whether on-wafer patterns stratifying relative information can be formed or not. FIG. 5 is a view illustrating a relation between a design layout and on-wafer patterns. The design layout 51 is prepared by an apparatus such as the design layout preparing apparatus 2.

In the mask pattern preparing apparatus 1B, the mask pattern preparing unit 14B prepares mask patterns using the design layout 51. At this time, the mask pattern preparing unit 14B prepares a lithography target by performing target mask data processing (MDP) using design data. Then, the mask pattern preparing unit 14B prepares the mask patterns by performing OPC on the lithography target. Thereafter, the determination unit 41 performs a lithography simulation using the mask patterns corrected by the OPC so as to estimate pattern shapes of the on-wafer patterns 52. Then, the determination unit 41 determines whether the shapes of the on-wafer patterns 52 satisfy relative information.

Next, an explanation will be given on a process of correcting mask patterns. FIGS. 6A and 6B are views for explaining a process of correcting mask patterns for circuit patterns requiring areal symmetry. In the following description, an exemplary case where mask patterns are required to have the same area will be explained as relative information.

The mask pattern preparing unit 14B prepares a pair of mask patterns R1 and R2 (not shown) by using a pair of design patterns regulated by relative information of same area requirement. Then, as shown in FIG. 6A, the determination unit 41 estimates a pair of on-wafer patterns P1 and P2 corresponding to the pair of mask patterns R1 and R2 by, for example, lithography simulation.

For example, an on-wafer pattern (ideal pattern) which is line-symmetrical to the on-wafer pattern P1 is determined as an on-wafer pattern Q2. The determination unit 41 compares the area of the on-wafer pattern P2 and the area of the on-wafer pattern Q2 and determines whether a shape difference (area difference) between the on-wafer patterns P2 and Q2 is equal to or smaller than a threshold value.

At this time, the determination unit 41 may use factors such as dimensions or areas of the on-wafer patterns P2 and Q2 as determination references. If the area difference is allowable when compared with a predetermined reference, the determination unit 41 allows the mask patterns R1 and R2 corresponding to the on-wafer patterns P1 and P2 (OK determination). For example, although a pattern group required to be symmetric is symmetrically deformed due to, for example, optical proximity effect, if the deformation is within a predetermined range so that desired device performance can be obtained, it is not necessary to correct mask patterns.

On the other hand, if the area difference is not allowable when compared with the predetermined reference, the determination unit 41 outputs an NG determination. In this case, the correction unit 42 corrects the mask pattern R2 corresponding to the on-wafer pattern P2 so that the area difference is allowable when compared with the predetermined reference. For example, the correction unit 42 corrects the mask pattern R2 corresponding to the on-wafer pattern P2 so that the area of the on-wafer pattern P2 can approach the area of the ideal on-wafer pattern Q2.

In addition, the determination unit 41 may correct the mask pattern R1 corresponding to the on-wafer pattern P1. In addition, the determination unit 41 may correct both the mask patterns R1 and R2 corresponding to the on-wafer patterns P1 and P2.

After the mask pattern R2 corresponding to the on-wafer pattern P2 is corrected, the determination unit 41 estimates on-wafer patterns corresponding to corrected mask patterns R1 and R2 by a method such as lithography simulation.

For example, as shown in FIG. 6B, the on-wafer pattern P2 is changed to an on-wafer pattern P4 having approximately the same area as the area of the on-wafer pattern Q2 by correcting the mask pattern R2. If an area difference between the on-wafer patterns P1 and P4 is allowable when compared with the predetermined reference, the determination unit 41 allows mask patterns corresponding to the on-wafer patterns P1 and P4.

If the area difference between the on-wafer patterns P1 and P4 is unallowable when compared with the predetermined reference, mask pattern correction and area difference determination are repeated by the correction unit 42 and the determination unit 41 until the area difference satisfies the predetermined reference.

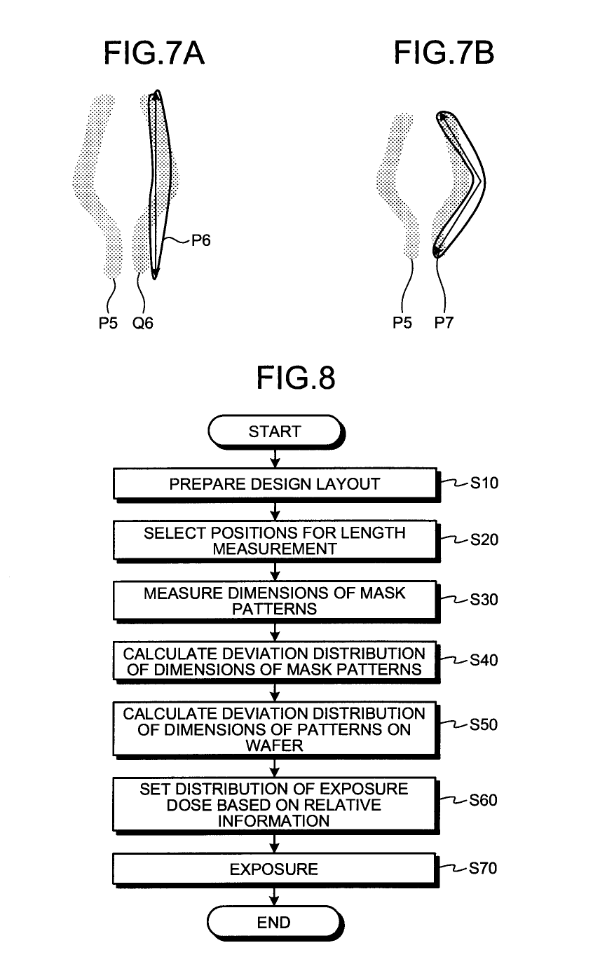

FIGS. 7A and 7B are views for explaining a process of correcting mask patterns for circuit patterns requiring length symmetry. In the following description, an exemplary case where mask patterns are required to have the same length will be explained as relative information.

The mask pattern preparing unit 14B prepares a pair of mask patterns R5 and R6 (not shown) by using a pair of design patterns regulated by relative information of same length requirement. Then, as shown in FIG. 7A, the determination unit 41 estimates a pair of on-wafer patterns P5 and P6 corresponding to the pair of mask patterns R5 and R6 by, for example, lithography simulation.

For example, an on-wafer pattern (ideal pattern) which is line-symmetrical to the on-wafer pattern P5 is determined as an on-wafer pattern Q6. The determination unit 41 compares the length of the on-wafer pattern P6 and the length of the on-wafer pattern Q6 and determines whether the length difference between the on-wafer patterns P6 and Q6 as a result of comparison is equal to or smaller than a threshold value.

If the length difference is allowable when compared with a predetermined reference, the determination unit 41 allows the mask patterns R5 and R6 corresponding to the on-wafer patterns P5 and P6 (OK determination). For example, although a pattern group required to be symmetric is deformed due to, for example, optical proximity effect, if the deformation is within a predetermined range so that desired device performance can be obtained, it is not necessary to correct mask patterns.

On the other hand, if the length difference is not allowable when compared with the predetermined reference, the determination unit 41 determines the mask patterns R5 and R6 as NG. In this case, the correction unit 42 corrects the mask pattern R6 corresponding to the on-wafer pattern P6 so that the length difference is allowable when compared with the predetermined reference. For example, the correction unit 42 corrects the mask pattern R6 corresponding to the on-wafer pattern P6 so that the length of the on-wafer pattern P6 can approach the length of the ideal on-wafer pattern Q6.

In addition, the determination unit 41 may correct the mask pattern R5 corresponding to the on-wafer pattern P5. In addition, the determination unit 41 may correct both the mask patterns R5 and R6 corresponding to the on-wafer patterns P5 and P6.

After the mask pattern R6 corresponding to the on-wafer pattern P6 is corrected, the determination unit 41 estimates on-wafer patterns corresponding to the corrected mask patterns R5 and R6 by a method such as lithography simulation.

For example, as shown in FIG. 7B, the on-wafer pattern P6 is changed to an on-wafer pattern P7 having approximately the same length as the length of the on-wafer pattern Q6 by correcting the mask pattern R6. If an length difference between the on-wafer patterns P5 and P7 is allowable when compared with the predetermined reference, the determination unit 41 allows mask patterns corresponding to the on-wafer patterns P5 and P7 (OK determination).

If the length difference between the on-wafer patterns P5 and P7 is unallowable when compared with the predetermined reference, mask pattern correction and length difference determination are repeated by correction unit 42 and the determination unit 41 respectively until the length difference satisfies the predetermined reference.

Alternatively, on-wafer patterns may be derived by performing a transferring test on a wafer instead of the lithography simulation. In this case, a mask is formed by using mask patterns prepared by the mask pattern preparing unit 14B, and an exposure process is performed on a resist formed on a wafer by using the mask. Then, resist patterns are obtained as on-wafer patterns by developing the wafer, and the on-wafer patterns are measured by, for example, a scanning electron microscope (SEM). The measured results are used as on-wafer patterns.

The on-wafer patterns may be patterns obtained after etching. Patterns after etching are patterns obtained after etching a wafer on which resist patterns are formed. In this case, for example, shapes of patterns after etching may be calculated by a process simulation such as an etching simulation. In addition, on-wafer patterns may be obtained by etching a wafer on which resist patterns obtained by a transferring test are formed.

As described with reference to FIGS. 6 and 7, shapes of patterns not satisfying circuit characteristics are corrected, and patterns not varying in circuit characteristics due to deformation are used. Therefore, the process yield of products can be improved. In addition, if a mask used in a transferring test satisfies a spec, the mask can be used for manufacturing a semiconductor device instead of discarding the mask due to the deviation from the reference. Therefore, fewer masks may be discarded.

In the above description of the present embodiment, mask patterns are corrected so that relative information can be satisfied. However, alternatively, design layouts and process conditions such as illumination conditions may be corrected so that relative information can be satisfied. In this case, for example, the correction unit 42 may calculate correction amounts of design layouts and correction amounts of process conditions.

For example, process conditions such as optical proximity effect correction and lithography compliance checks may be optimized. In addition, process conditions such as illumination shapes, illumination distribution, NA, polarized light condition, dynamic focus setting, mask types, amounts of exposure light, aberration, resist kinds, resist thickness, post exposure bake (PEB), developing conditions may be optimized.

As described above, according to the second embodiment, on-wafer patterns are evaluated based on relative information, and if an on-wafer pattern is determined as NG, a mask pattern is corrected based on relative information. Therefore, designed patterns can be formed on a wafer according to designed pattern groups. Therefore, deviations of on-wafer patterns can be reduced, and thus circuits having desired electric characteristics can be formed with improved process yield. Therefore, semiconductor devices can be manufactured with high process yield and low costs.

### Third Embodiment

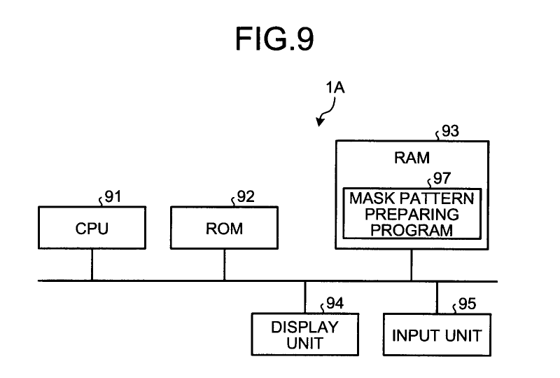

Next, a third embodiment of the present invention will be described with reference to FIGS. 8 and 9. In the third embodiment, for example, the mask pattern preparing apparatus 1B sets an exposure dose map so that on-wafer patterns can satisfy relative information. Therefore, relative information of the present embodiment is related to requirements between on-wafer patterns.

FIG. 8 is a flowchart illustrating a process of preparing a dose map based on relative information. After a design layout is prepared (Step S10), positions are selected from the design layout for measuring lengths such as pattern dimensions (Step S20). The selection may be carried out by using a predetermined program or according to commands of an operator. For example, design patterns having certain widths may be selected.

Thereafter, the mask pattern preparing unit 14B prepares mask patterns using the design layout, and the determination unit 41 measures dimensions of the mask patterns (Step S30). Then, the determination unit 41 calculates deviation distribution of the dimensions of the mask patterns (Step S40). In addition, the determination unit 41 calculates deviation distribution of dimensions of on-wafer patterns in consideration of factors such as mask error factors (MEFs) (Step S50).

Next, the correction unit 42 sets an exposure dose amount distribution (dose map) based on relative information (Step S60). For example, if a portion of a pattern has a possibility of an electric defect and the possibility is greater than a predetermined value, the dose map is set to widen or narrow the portion of the pattern. In this way, the exposure dose is optimized by an exposure dose mapping method. In detail, dose deviations are measured from an exposure surface in a slit direction and a scanning direction so as to optimize dose mapping at each position, and exposure is performed (Step S70).

In the related art, dose deviations are calculated based on distributions of mask pattern dimensions and on-wafer pattern dimensions so as to determine an exposure dose. That is, since the dose is determined without considering positions important in terms of circuits and positions requiring symmetry, there are high possibilities of insufficient margins of electric characteristics and unallowable device characteristics. Therefore, in the present embodiment, exposure dose mapping is carried out in consideration of positions important in terms of circuits and positions requiring symmetry. At this time, the dose is adjusted in order to improve symmetry. In this way, symmetry of on-wafer patterns can be improved to increase performance and yield and decrease chip costs.

Next, hardware structures of the mask pattern preparing apparatuses 1A and 1B will be described. Since the mask pattern preparing apparatuses 1A and 1B have the same hardware structure, the hardware structure of the mask pattern preparing apparatus 1A will be described in the following description.

FIG. 9 is a view illustrating the hardware structure of the mask pattern preparing apparatus 1A. The mask pattern preparing apparatus 1A includes a central processing unit (CPU) 91, a read only memory (ROM) 92, a random access memory (RAM) 93, a display unit 94, and an input unit 95. In the mask pattern preparing apparatus 1A, the CPU 91, the ROM 92, the RAM 93, the display unit 94, and the input unit 95 are connected to each other through bus lines.

The CPU 91 performs a pattern determination by a mask pattern preparing program 97 which is a computer program. The display unit 94 is a display device such as a liquid crystal monitor for displaying information such as design patterns, requirements, relative information, and mask patterns based on instructions of the CPU 91. The input unit 95 includes a mouse and a keyboard so that an operator can input commands (such as parameters necessary to prepare mask patterns) through the input unit 95. Command information input through the input unit 95 is sent to the CPU 91.

The mask pattern preparing program 97 is stored in the ROM 92 and loaded on the RAM 93 through bus lines. FIG. 9 illustrates a state where the mask pattern preparing program 97 is loaded on the RAM 93.

The CPU 91 executes the mask pattern preparing program 97 loaded on the RAM 93. In detail, if an operator inputs a command to the mask pattern preparing apparatus 1A through the input unit 95, the CPU 91 reads the mask pattern preparing program 97 from the ROM 92 and loads the mask pattern preparing program 97 in a program region of the RAM 93 so as to perform various processes. The CPU 91 performs control such that various data generated during such various processes are temporarily stored in a data region of the RAM 93.

The mask pattern preparing program 97 executed in the mask pattern preparing apparatus 1A has a module configuration including the mask pattern preparing unit 14A. The module configuration is present on a main memory device by loading the mask pattern preparing program 97 on the main memory device. A mask pattern preparing program 97 executed in the mask pattern preparing apparatus 1B has a module configuration including the mask pattern preparing unit 14B, the determination unit 41, and the correction unit 42.

As described above, according to the third embodiment, an exposure dose map is set so that on-wafer patterns can satisfy relative information. Therefore, designed patterns can be formed on a wafer according to designed pattern groups. Therefore, deviations of on-wafer patterns can be reduced, and thus circuits having desired electric characteristics can be formed with improved process yield. Therefore, semiconductor devices can be manufactured with high process yield and low costs.

As described above, according to the first to third embodiments, mask patterns can be prepared for manufacturing semiconductor devices with high process yield and low costs.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method of preparing a pattern, the method comprising:
preparing mask patterns corresponding to on-substrate patterns so as to form the on-substrate patterns according to design patterns,
wherein the mask patterns are prepared based on a correlation which needs to be satisfied between the design patterns so that a relation which same the correlation is satisfied between the mask patterns corresponding to the design patterns.

2. The method of claim 1, wherein the correlation comprises at least one of symmetry in the design patterns, identity of the design patterns, lengths of the design patterns, shapes of the design patterns, the number of via holes of the design patterns, and the number of curved portions of the design patterns.

3. The method of claim 1, wherein the correlation is a requirement between the design patterns to be satisfied to implement a circuit function.

4. The method of claim 1, wherein the design patterns correspond to design blocks, circuits, or individual patterns.

5. The method of claim 1, wherein a lithography target is prepared by performing a mask data processing process on the design patterns, and the mask patterns are prepared by performing an optical proximity correction (OPC) process on the lithography target which is based on the correlation.

6. The method of claim 1, wherein a lithography target is prepared by performing a mask data processing process on the design patterns, and the mask patterns are prepared by performing an OPC process on the lithography target and subjecting the resultant of the OPC process to correction based on the correlation.

7. The method of claim 1, wherein when the mask patterns are prepared, a dummy pattern is arranged, the dummy pattern being equivalent to a pattern group in which patterns are expected to have the same shape.

8. A method of preparing a pattern, the method comprising:
preparing mask patterns corresponding to on-substrate patterns so as to form the on-substrate patterns corresponding to design patterns;
deriving the on-substrate patterns using the mask patterns; and
correcting the mask patterns or the design patterns based on the derived on-substrate patterns and a correlation which needs to be satisfied between the design patterns, so that the correlation is satisfied between the on-substrate patterns corresponding the mask patterns.

9. The method of claim 8, wherein the correlation comprises at least one of symmetry in the design patterns, identity of the design patterns, lengths of the design patterns, shapes of the design patterns, the number of via holes of the design patterns, and the number of curved portions of the design patterns.

10. The method of claim 8, wherein the correlation is a requirement between the design patterns to be satisfied to implement a circuit function.

11. The method of claim 8, wherein the design patterns correspond to design blocks, circuits, or individual patterns.

12. A method of preparing a pattern, the method comprising:
preparing mask patterns corresponding to on-substrate patterns so as to form the on-substrate patterns corresponding to design patterns, wherein the mask patterns are prepared based on a correlation which needs to be satisfied between the design patterns so that a relation which same the correlation is satisfied between the mask patterns corresponding to the design patterns;
preparing a mask using the mask patterns; and
forming the on-substrate patterns on a substrate using the mask.

13. The method of claim 12, wherein the correlation corresponds to at least one of symmetry in the design patterns, identity of the design patterns, lengths of the design patterns, shapes of the design patterns, the number of via holes of the design patterns, and the number of curved portions of the design patterns.

14. The method of claim 12, wherein the correlation is a requirement between the design patterns to be satisfied to implement a circuit function.

15. The method of claim 12, wherein the design patterns corresponds to design blocks, circuits, or individual patterns.

16. The method of claim 12, wherein a lithography target is prepared by performing a mask data processing process on the design patterns, and the mask patterns are prepared by performing an OPC process on the lithography target which is based on the correlation.

17. The method of claim 12, wherein a lithography target is prepared by performing a mask data processing process on the design patterns, and the mask patterns are prepared by performing an OPC process on the lithography target and subjecting the resultant of the OPC process to correction based on the correlation.

18. The method of claim 12, wherein when the mask patterns are prepared, a dummy pattern is arranged, the dummy pattern being equivalent to a pattern group in which patterns are expected to have the same shape.

19. A computer program product comprising a computer-readable recording medium storing a plurality of commands that are executable by a computer and configured to prepare mask patterns, wherein the plurality of commands cause a computer to execute preparing mask patterns so as to satisfy a correlation between the mask patterns corresponding to design patterns, based on a correlation which needs to be satisfied between the design patterns when the mask patterns corresponding to on-substrate patterns are formed so that the on-substrate patterns corresponding to the design patterns are formed.

20. A computer program product comprising a computer-readable recording medium storing a plurality of commands that are executable by a computer and are configured to prepare mask patterns, the plurality of commands causing a computer to execute the followings:
prepare mask patterns corresponding to on-substrate patterns to form the on-substrate patterns corresponding to design patterns;
derive the on-substrate patterns using the mask patterns; and
correcting the mask patterns or the design patterns based on the derived on-substrate patterns and a correlation which needs to be satisfied between the design patterns, so that the correlation is satisfied between the on-substrate patterns corresponding the mask patterns.
